(19) United States
(12) Patent Application Publication
(10) Pub. No.: US 2022/0223840 A1
(43) Pub. Date: Jul. 14, 2022

(54) LITHIUM SECONDARY BATTERY

(71) Applicant: The Furukawa Battery Co., Ltd., Yokohama-shi (JP)

(72) Inventor: Yuta Kobayashi, Iwaki-shi (JP)

(73) Assignee: The Furukawa Battery Co., Ltd., Yokohama-shi (JP)

(21) Appl. No.: 17/708,551

(22) Filed: Mar. 30, 2022

Related U.S. Application Data
(63) Continuation of application No. PCT/JP2021/006998, filed on Feb. 25, 2021.

(30) Foreign Application Priority Data
Oct. 19, 2020 (JP) 2020-175476

(51) Int. Cl. H01M 4/36; H01M 4/505; H01M 10/0567; H01M 4/62; H01M 4/525; H01M 4/58; H01M 10/0525; H01M 10/0569

(52) U.S. Cl. CPC H01M 4/364; H01M 4/505; H01M 10/0567; H01M 4/625; H01M 2004/021; H01M 4/5825; H01M 10/0525; H01M 10/0569; H01M 4/525

(57) ABSTRACT

A lithium secondary battery includes a positive electrode, a negative electrode, and non-aqueous electrolyte, wherein the positive electrode includes a current collector and a positive electrode mixture layer formed on at least one surface of the current collector, the first conductive material has particle diameter distribution D₉₀ between 3 and 20 μm, the first conductive material has a crystallite diameter between 1 and 10 nm, the crystallite diameter being obtained by a Scherrer's equation based on a peak intensity attributed to (102) face in which 2θ exists within a range of 50 to 52° in an X-ray diffraction pattern derived by means of an X-ray diffraction measurement using Cu-Kα, the second conductive material has an average particle diameter size between 10 and 100 nm, and density of the positive electrode mixture layer is between 2.3 and 2.9 g/cm³.

### CROSS-REFERENCE TO RELATED APPLICATIONS

This application is a continuation of International Application No. PCT/JP2021/006998, filed on Feb. 25, 2021, which claims priority to and the benefit of Japanese Patent Application No. 2020-175476 filed on Oct. 19, 2020. The disclosures of the above applications are incorporated herein by reference.

### FIELD

The present application describes a lithium secondary battery.

### BACKGROUND

In recent years, lithium secondary batteries are widely used because of their high energy density, and the like, and are equipped in mobile devices such as mobile phone, digital camera, clamshell computer, and the like as power sources thereof. Furthermore, lithium secondary batteries have been developed for hybrid cars, electric cars, and industrial uses such as power storage of natural energy power generator such as solar, and wind from the viewpoint of energy resource depletion, global warming, and the like. That is, a lithium secondary battery with a higher density and a longer life has been demanded for such a wide use.

In a lithium secondary battery, charge/discharge will be performed by moving lithium ions between a positive electrode and a negative electrode. The positive electrode includes a positive electrode current collector and a positive electrode mixture layer containing a positive electrode active material formed on at least one surface of the positive electrode current collector. As a positive electrode active material, lithium-containing metal oxides or metal phosphates such as lithium cobalt oxide (LiCoO₂), lithium manganate (LiMn₂O₄), lithium nickel oxide (LiNiO₂), and lithium iron phosphate (LiFePO₄) are practically used, or have been developed for commercialization.

The negative electrode includes a negative electrode current collector and a negative electrode layer containing a negative electrode active material formed on one or both surfaces of the negative electrode current collector. The negative electrode active material is metallic lithium, lithium alloy, carbon material such as graphite, lithium titanium oxide (Li₄Ti₅O₁₂), and the like. A separator is interposed between the positive electrode and the negative electrode to prevent an internal short circuit. Generally, a microporous membrane of polyolefin is used as the separator.

Currently, lithium secondary batteries are required not only to have high energy density but also to have excellent cycle characteristics and storage performance to withstand long-term use. However, lithium nickel cobalt manganate (LiNiₓCo_{y}Mn_{1-x-y}O₂, hereinafter may be referred to as NCM), and lithium nickel cobalt aluminate (LiNiₓCo_{y}Al_{1-x-y}O₂, hereinafter may be referred to as NCA) are positive electrode active materials with high energy density while their low cycle and storage performances are problematic.

When lithium ions are desorbed from the active material by charging, the crystal structure of NCM or NCA becomes unstable, causing a transition of the crystal structure or grain boundary cracking of the active material, resulting in a reduction in capacity.

For this reason, it has been proposed to form a film on the surface of the positive electrode active material by using an additive in the electrolyte to prevent the aforementioned crystal structure transition or grain boundary cracking of the active material, thereby improving the cycle performance and storage performance. For example, in Patent Literature 1 (JP 2017-22142 A), it is discloses to form a mixed film on the surface of a positive electrode active material by adding lithium difluorobisoxalate phosphate and lithium tetrafluoroxalate phosphate, thereby suppressing an increase in DC resistance after high temperature storage and improving high temperature storage performance. Patent Literature 2 (JP 2013-206793 A) discloses that, by using a cyclic sulfonic acid compound as an additive, Mn in the positive electrode active material is suppressed from dissolving and moving to the negative electrode side, thereby preventing degradation of the positive electrode and improving the charge-discharge cycle performance to a certain percentage.

Since the reaction of the film formation by the additive in the electrolyte occurs on the surface of the positive electrode active material, the surface shape of the positive electrode mixture layer greatly contributes to the film formation. The surface shape of the positive electrode mixture layer can be changed according to the electrode specifications, such as the density of the electrode mixture and the physical properties of the conductive material, which greatly contributes to the improvement of the cycle characteristics.

However, in Patent Literatures 1 and 2, the composition of the positive electrode active material and the type of additive in the electrolyte are specified. Patent Literatures 1 and 2 does not disclose what specific positive electrode should be used when using the additive in the electrolyte in order to maximize the cycle characteristics.

On the other hand, Patent Literature 3 (JP 2004-22177 A) discloses that the use of both carbon black and graphite as the conductive materials used in the positive electrode mixture improves the high rate discharge characteristics and charge-discharge cycle performance. However, as mentioned above, in order to form a surface shape of the positive electrode mixture layer that allows for appropriate film formation, it is necessary for the conductive material to have good crystallinity and for the electrode specifications to be such that it uniformly covers the area around the positive electrode active material. For this purpose, it is preferable to use a conductive material having an optimum particle diameter or crystallite diameter. However, in the conventional technology including Patent Literature 3, this point has not been clarified, and there was a problem that sufficient cycle characteristics could not necessarily be achieved.

Furthermore, the prior art, including Patent Literatures 1 to 3, does not propose a method of suppressing a decrease in a discharge voltage after a charge-discharge cycle. A “charge-discharge cycle performance” disclosed in Patent Literatures 1 to 3 refers to the ratio of the post-cycle capacity to the pre-cycle capacity, i.e., a cycle capacity maintenance rate. Thus, in general, charge-discharge cycle performance almost always refers to the cycle capacity maintenance rate, but in reality, the decrease in the discharge voltage before and after the cycle is also an important issue. If the discharge voltage decreases due to charge-discharge cycle, the output and energy density as a lithium secondary battery will decrease. Depending on the composition of the positive electrode active material and the electrolyte, because the cycle capacity maintenance rate is good, even if there is no apparent degradation, the amount of discharge power is reduced due to a decrease in the discharge voltage, and in effect, performance can deteriorate significantly due to charge-discharge cycles. In spite of these issues, most of the efforts in the development of conventional technologies have focused only on the cycle capacity maintenance rate, and methods to improve both the capacity and the discharge voltage performance after charge-discharge cycles have not been studied.

### SUMMARY

The present disclosure relates to a lithium secondary battery including a layered compound of lithium nickel cobaltate such as NCM or NCA as the first positive electrode active material. By diligently exploring the density of the positive electrode mixture layer containing the first positive electrode active material and the specification of the appropriate conductive material in the positive electrode mixture layer, it has been discovered to reduce the degradation of capacity and the discharge voltage before and after charge/discharge cycles, which is not disclosed in the prior art.

According to an embodiment, a lithium secondary battery includes a positive electrode, a negative electrode, and a non-aqueous electrolyte. The positive electrode includes a current collector and a positive electrode mixture layer formed on at least one surface of the current collector. The positive electrode mixture contains a first positive electrode active material made of a layered compound represented by a general formula: LiₐNiₓCo_{y}M_{1-x-y}O₂ (where, in the formula, M is at least one selected from a group of Ti, Zr, Nb, W, P, Al, Mg, V, Mn, Ca, Sr, Cr, Fe, B, Ga, In, Si, Mo, Y, Sn, Cu, Ag, and Zn, and a, x, and y are 0.9≤a≤1.2, 0.5≤x≤0.9, 0.1≤y≤0.3 respectively), a first conductive material, and a second conductive material. The first conductive material has particle diameter distribution D₉₀ between 3 and 20 μm, and has a crystallite diameter between 1 and 10 nm, the crystallite diameter being obtained by a Scherrer's equation based on a peak intensity attributed to (102) face in which 2θ exists within a range of 50 to 52° in an X-ray diffraction pattern derived by means of an X-ray diffraction measurement using Cu-Kα. The second conductive material has an average particle diameter size between 10 and 100 nm. Density of the positive electrode mixture layer is between 2.3 and 2.9 g/cm³.

Additional objects and advantages of the disclosure will be set forth in the description which follows, and in part will be obvious from the description, or may be learned by practice of the disclosure. The objects and advantages of the disclosure may be realized and obtained by means of the instrumentalities and combinations particularly pointed out hereinafter.

### Effects of Disclosure

According to an embodiment, in a lithium secondary battery using a layered compound of nickel cobaltate lithium such as NCM or NCA as a positive electrode active material, the degradation of the cycle capacity maintenance rate and a discharge voltage maintenance rate can be suppressed.

### DETAILED DESCRIPTION

The structures and working effect of the lithium secondary battery according to an embodiment will be described hereinafter. The embodiments describe examples, and are not limited thereto. Various changes or improvements may be added to the embodiments, and the embodiments with such changes or improvements may be included in the present disclosure. However, although the mechanism described herein includes a presumption, the success or failure of the presumption does not limit the disclosure in any way.

A lithium secondary battery of an embodiment includes a positive electrode, a negative electrode, a non-aqueous electrolyte, and a separator disposed between the positive electrode and the negative electrode.

The positive electrode includes a positive electrode current collector and a positive electrode mixture layer formed on at least one surface of the positive electrode current collector. Although there are no particular restrictions on the material for the positive electrode current collector, it is preferable to use a metal. Specifically, for example, aluminum, nickel, stainless steel, titanium, and other alloys are mentioned. Among these, aluminum is preferred from the viewpoint of electronic conductivity and battery operating potential. The thickness of the positive electrode current collector is preferably 1 to 50 μm.

The positive electrode mixture layer includes a first positive electrode active material, a first conductive material, and a second conductive material.

The first positive electrode active material is a layered compound represented by a general formula: LiₐNiₓCo_{y}M_{1-x-y}O₂ (where, in the formula, M is at least one selected from a group of Ti, Zr, Nb, W, P, Al, Mg, V, Mn, Ca, Sr, Cr, Fe, B, Ga, In, Si, Mo, Y, Sn, Cu, Ag, and Zn, and a, x, and y are 0.9≤a≤1.2, 0.5≤x≤0.9, 0.1≤y≤0.3 respectively). The specific layered compound is lithium nickel cobalt manganate (LiNiₓCo_{y}Mn_{1-x-y}O₂, hereinafter may be referred to as NCM), or lithium nickel cobalt aluminate (LiNiₓCo_{y}Al_{1-x-y}O₂, hereinafter may be referred to as NCA). However, in the formula, x and y are 0.5≤x≤0.9 and 0.1≤y≤0.3, respectively.

The first positive electrode active material preferably has an average particle diameter of between 1 and 100 μm, and more preferably between 1 and 20 μm.

The first positive electrode active material is preferably coated on the surface with an inorganic material such as magnesium oxide, aluminum oxide, aluminum fluoride, niobium oxide, titanium oxide and tungsten oxide, or an ion-conductive polymer film such as polyethylene glycol, polyethylene oxide, their derivatives or salts. The formation of the film on the surface of the first positive electrode active material makes it possible to improve the cycle characteristics of the lithium secondary battery. The film may be distributed on the surface of the first positive electrode active material with a uniform thickness or with a non-uniform thickness. Furthermore, the film may cover the entire surface of the first positive electrode active material or a part of the surface thereof. However, if the surface area of the first positive electrode active material covered by the film is small, it may be difficult to improve the cycle characteristics. For this reason, it is preferable that the film covers 50% or more of the surface of the first positive electrode active material. In the formation of the film, the film thickness and the surface area to be covered can be adjusted by conventional known methods, such as a gas-phase method such as sputtering or CVD or a liquid-phase method in which the first positive electrode active material is impregnated in a film precursor solution under optimum conditions (pH, temperature, concentration, etc.). In addition, a coating material having a particle diameter of 0.1 μm or less can be mixed with the first positive electrode active material and heat-treated under conditions (temperature, holding time, etc.) suitable for the coating material to coat 50% or more of the surface of the first positive electrode active material.

The first conductive material has a particle diameter distribution D₉₀ of between 3 and 20 μm, and the crystallite diameter of between 1 and 10 nm. The crystallite diameter is obtained by the Scherrer's equation from the peak intensity attributed to the (102) face in which 2θ exists within a range of 50° to 52° in an X-ray diffraction pattern obtained by means of an X-ray diffraction measurement using a Cu-Kα. Such a first conductive material comprises a graphite or a graphene, such as a scaly graphite. In particular, it is preferred that the first conductive material is graphite.

By making the particle diameter distribution D₉₀ of the first conductive material between 3 and 20 μm, the first conductive material can enter a relatively large gap between the first positive electrode active materials, thus ensuring a conductive path and obtaining a positive electrode that contributes to good cycle characteristics. In addition, it is possible to obtain a positive electrode having a crystallite diameter of between 1 and 10 nm, which is calculated by the Scherrer's formula from the peak intensity of the peak attributed to the (102) plane existing in the range of 2θ of 50 to 52° in the X-ray diffraction pattern obtained by X-ray diffraction measurement using the Cu-Kα line. By making the crystallite diameter between 1 and 10 nm, the first conductive material has moderate crystallinity and maintains high electrical conductivity, and also prevents the destruction of the crystalline structure of the first conductive material by the insertion of anion species in the electrolyte between the crystalline layers, thereby improving the cycle characteristics.

Therefore, the first conductive material with the aforementioned characteristics can form an appropriate conductive path between the first positive electrode active materials to obtain excellent cycling characteristics.

If the particle diameter distribution D₉₀ of first conductive material is less than 3 μm, it becomes difficult to fill the large gap between the first positive electrode active materials with the first conductive material, a good conductive path cannot be formed, and it is difficult to improve the cycle characteristics. On the other hand, if the particle diameter distribution D₉₀ exceeds 20 μm, the particle diameter of the first conductive material becomes relatively larger than that of the first positive electrode active material, which prevents uniform dispersion of the first positive electrode active material, and a cycle characteristics cannot be improved.

When the crystallite diameter of the first conductive material is less than 1 nm, the crystallinity of the first conductive material is low, the conductivity is low, and the cycle characteristic is low. On the other hand, if the crystallite diameter of the first conductive material exceeds 10 nm, the crystallinity of the first conductive material is too high and the anion species in the non-aqueous electrolyte are inserted between the crystalline layers of the first conductive material, destroying the crystalline structure, resulting in loss of the conductive path, and degradation of the cycle characteristics.

The second conductive material has an average particle diameter of between 10 and 100 nm. Such a second conductive material includes at least one material selected from, for example, carbon black, activated carbon, and carbon fiber.

By making the average particle diameter of the second conductive material between 10 and 100 nm, the second conductive material can enter a relatively small gap between the first positive electrode active materials to ensure a conductive path and obtain a positive electrode that contributes to good cycle characteristics.

If the average particle diameter of the second conductive material is less than 10 nm, the particle diameter of the second conductive material is small and its dispersibility in the positive electrode mixture layer deteriorates, making it difficult to coat the first positive electrode active materials uniformly, and thus, a good conductive path cannot be formed, and the cycle characteristics degrade. On the other hand, when the average particle diameter of the second conductive material exceeds 100 nm, the particle diameter of the second conductive material is large and it becomes difficult to enter into the relatively small gap between the positive electrode active materials, and thus, a good conductive path cannot be formed, and the cycle characteristics degrade.

The density of the positive electrode mixture layer is between 2.3 and 2.9 g/cm³. If the density of the positive electrode mixture layer is less than 2.3 g/cm³, the first positive electrode active material is not tightly bonded to each other, and during charging and discharging, the first positive electrode active material flows out into the non-aqueous electrolyte, causing a decrease in capacity and lowering the cycle characteristic. On the other hand, if the density of the positive electrode mixture layer exceeds 2.9 g/cm³, the positive electrode mixture layer does not have adequate gaps, which makes it difficult for the non-aqueous electrolyte to penetrate, resulting in non-uniform film formation and lower cycle characteristics.

The positive electrode mixture layer, preferably, further includes a second positive electrode active material comprising LiCoO₂ alone or a mixture of LiCoO₂ and LiMn₂O₄ or LiMnₓFe₁₋ₓPO₄ (where x is 0.5≤x≤0.9). The weight ratio of the first positive electrode active material to the total weight of said first positive electrode active material and said second positive electrode active material is preferably 50% or more by weight from the viewpoint of improving the energy density, and is preferably 90% or less by weight from the viewpoint of improving the desired characteristics such as output characteristics or thermal stability.

It is preferred that the positive electrode mixture layer further includes a second positive electrode active material comprising at least one selected from LiMn₂O₄ and LiMnₓFe₁₋ₓPO₄ (where x is 0.5≤x≤0.9). The weight ratio of the first positive electrode active material to the total weight of said first positive electrode active material and said second positive electrode active material is preferably 60% or more by weight from the viewpoint of improving energy density, and is preferably 90% or less by weight from the viewpoint of improving desired characteristics such as output characteristics or thermal stability.

In the positive electrode mixture layer formed on at least one side of the current collector, it is preferable that the amount of the positive electrode mixture layer applied per side thereof is between 75 to 150 g/m². By specifying the coating amount of the positive electrode mixture layer, it is possible to secure a sufficient energy density and to maintain good output characteristics and cycle characteristics.

The negative electrode includes a negative electrode current collector and a negative electrode mixture layer formed on at least one surface of the negative electrode current collector. Although there are no particular restrictions on the material for the negative electrode current collector, it is preferable to use a metal. Specifically, for example, aluminum, copper, nickel, stainless steel, titanium, and other alloys are mentioned. Among them, copper is preferable from the viewpoint of electronic conductivity and battery operating potential. In addition, the thickness of the negative electrode current collector is preferably 1 to 50 μm.

The negative electrode active material is not particularly limited, and includes, for example, metallic lithium, lithium alloy, graphite, amorphous carbon, Si, SiOₓ (where x is 0<x≤2), transition metal composite oxides (e.g., Li₄Ti₅O₁₂, TiNb₂O₇, etc.), and alloys capable of absorbing and releasing lithium. In particular, graphite is preferred as a negative electrode active material because it has a working potential that is extremely close to metallic lithium and enables charging and discharging to be performed at a high working voltage.

The non-aqueous electrolyte includes a lithium salt and a non-aqueous solvent. Lithium salt may be, for example, one or a mixture of two or more types selected from LiBF₄, LiPF₆, Li(FSO₂)₂N, Li(CF₃SO₂)₂N, and the like, but is not necessarily limited thereto. The concentration of the lithium salt is preferably between 0.5 and 5 mol/L, and even more preferably between 0.8 and 1.5 mol/L.

A non-aqueous solvent may be, but be not limited to, one or a mixture of two or more selected from, for example, dimethyl carbonate (DMC), diethyl carbonate (DEC), dipropyl carbonate (DPC), ethyl methyl carbonate (EMC), ethylene carbonate (EC), propylene carbonate (PC), methyl propionate, methyl acetate, methyl formate, methyl butyrate, dioxolane, 2-methyltetrahydrofuran, tetrahydrofuran, dimethoxyethane, γ-butyrolactone, acetonitrile, and benzonitrile. DMC, DEC, DPC, EMC, EC, and PC are particularly preferred, and in terms of good film formation on the negative electrode active material, it is particularly preferred to include EC.

When the non-aqueous solvent is a mixed solvent containing ethylene carbonate, dimethyl carbonate, and ethyl methyl carbonate, it is preferred that the composition ratio of ethylene carbonate is between 15% and 30% by volume. Furthermore, it is preferred that the composition ratio of ethyl methyl carbonate is between 35% and 60% by volume for better cycle characteristics and output characteristics. The ratio of the composition ratio of dimethyl carbonate (B) to the composition ratio of ethyl methyl carbonate (A) (B/A=C) is preferably 0.4≤C≤1.0. By satisfying such a relationship, it is possible to exhibit good cycle characteristics under both low and high temperature environments and to maintain the viscosity of the non-aqueous solvent within a good range.

The non-aqueous electrolyte further contains a first additive and a second additive preferably.

The first additive is at least one material selected from vinylene carbonate (VC) and fluoroethylene carbonate (FEC). The first additive has a preferred loading of between 0.5% and 5% by weight of the total weight of the non-aqueous electrolyte, and a more preferred loading of between 1.0% and 3.5% by weight.

By including such a first additive in the non-aqueous electrolyte, a high quality film is formed on the surface of the negative electrode active material mainly by reductive decomposition during charging and discharging, which suppresses the decrease in a coulombic efficiency and enables stable charging and discharging over a long period of time.

The second additive is one or a mixture of two or more selected from 1,3,2-dioxathiolane 2,2-dioxide (MMDS), 1,5,2,4-dioxadithiane 2,2,4,4-tetraoxide, phosphorous acid tris (trimethylsilyl), 1-propene 1,3-sultone, Li₂PO₂F₂. The preferred loading is between 0.1% and 2% by weight of the total weight of the non-aqueous electrolyte, and a more preferred loading is between 0.5% and 1.5% by weight.

By including such a second additive in the non-aqueous electrolyte, a film is formed on the surface of the positive electrode active material mainly by oxidative decomposition during charging and discharging. The first positive electrode active material particles are protected from the oxidation reaction of the non-aqueous electrolyte, and the crystal structure is prevented from collapsing, thus improving the cycle characteristics.

Therefore, by further adding the first additive and the second additive to the non-aqueous electrolyte, a film of optimum composition is formed on the surface of the first positive electrode active material. Therefore, a lithium secondary battery with suppressed the capacity decreasing, the discharge voltage decreasing, and the coulombic efficiency decreasing can be realized even after charge-discharge cycles.

The separator can be, for example, a porous sheet made of polymer or fiber, or a non-woven fabric. It is preferred the separator have a pore diameter of 0.01 to 10 μm and a thickness of 5 to 30 μm. The separator may have a structure in which a ceramic layer is laminated on a porous substrate as a heat-resistant insulating layer.

As described above, according to an embodiment, a lithium secondary battery including a layered compound of nickel-cobaltate-based lithium such as NCM or NCA as a first positive electrode active material, wherein the density of the positive electrode mixture layer including the first positive electrode active material is defined, and wherein a specific first conductive material and second conductive material are included in the positive electrode mixture layer. Therefore, the lithium secondary battery can be provided with excellent charge-discharge cycle characteristics that have not been disclosed in the conventional art, and can suppress the decrease in capacity and the discharge voltage before and after charge-discharge cycles.

In addition, according to the embodiment, by adding a specific first additive and second additive at a predetermined loading each to the non-aqueous electrolyte, it is possible to form a film of optimum composition on the surface of the first positive electrode active material, thereby providing a lithium secondary battery with high performance that suppresses degradation of capacity, the discharge voltage and the coulombic efficiency even after charge-discharge cycles.

### EXAMPLES

The present disclosure is described in more detail by way of examples below, but the present disclosure is not limited in any way to the following forms.

[A]: A Study of the Effect of Density of Positive Electrode Mixture

### Examples 101-103 and Comparative Examples 101, 102

Preparation of Positive Electrode

90% by weight of LiNi_{0.5}Co_{0.2}Mn_{0.3}O₂ (NCM) as the first positive electrode active material, 3% by weight of graphite (D₉₀: 4.7 μm, crystallite diameter: 5.1 nm) as the first conductive material, 3% by weight of acetylene black (average particle diameter: 35 nm) as the second conductive material, 4% by weight of polyvinylidene fluoride (PVDF) as the binder, and an appropriate amount of N-methyl-2-pyrrolidone (NMP) as the viscosity control solvent were mixed to prepare a positive electrode active material slurry.

The obtained positive electrode active material slurry was applied to one side of a 20 μm thick aluminum foil, which is a positive electrode current collector, and dried to form a positive electrode mixture layer. The positive electrode mixture layer was then pressed by a roll press machine to prepare five types of positive electrodes. Note that, the amount of the positive electrode mixture layer applied per one side was set to 96 g/m². In addition, the density of the positive electrode mixture layer was adjusted to be in the range of 2.2 to 3.0 g/cm³.

Preparation of Negative Electrode

The negative electrode was obtained by laminating a 300 μm thick lithium metal foil on a 100 μm thick stainless steel foil current collector.

Preparation of Non-Aqueous Electrolyte

The lithium salt LiPF₆ was dissolved at a concentration of 1.3 mol/L in a mixture of ethylene carbonate, ethyl methyl carbonate and dimethyl carbonate in the ratio of 2:5:3 by volume. To this solution, fluoroethylene carbonate (FEC) was added as a first additive and 1,3,2-dioxathiolane 2,2-dioxide (MMDS) as a second additive to prepare non-aqueous electrolyte. The loading of FEC was set at 2% by weight of the total weight of the non-aqueous electrolyte, and the loading of MMDS was set at 1% by weight of the total weight of the non-aqueous electrolyte.

Fabrication of the Battery

A 2032 coin-shaped lithium secondary battery (hereinafter simply referred to as a coin-shaped battery) was fabricated using the aforementioned five types of positive electrodes, negative electrode, non-aqueous electrolyte, and polyolefin microporous membrane as a separator, as in Examples 101 to 103 and Comparative Examples 101 and 102. The coin-shaped batteries were fabricated in an argon atmosphere with a dew point of −50° C. or lower.

Initial Activation Process

The coin-shaped batteries of Examples 101 to 103 and Comparative Examples 101 and 102 were transferred to a thermostatic bath set at 25° C. and subjected to an initial activation process of five cycles. In the first cycle, a constant-current and constant-voltage charge with a current of 0.1 C, a voltage of 4.3 V, and a cutoff current of 0.05 C, and a constant-current discharge with a current of 0.1 C and a termination voltage of 2.75 V were performed. In the second to fifth cycles, constant-current and constant-voltage charging with a current of 0.2 C, a voltage of 4.3 V, and a cutoff current of 0.05 C, and constant-current discharging with a current of 0.2 C and a termination voltage of 2.75 V were performed. A pause time of 15 min was set after charging and discharging.

25° C. Cycle Test

After the initial activation process was completed, each coin-shaped battery was subjected to a 20-cycle cycle test at 25° C. in a thermostatic bath. The charging conditions were constant current charging at a current of 0.5 C and a termination voltage of 4.3 V, and the discharging conditions were constant current discharging at a current of 0.5 C and a termination voltage of 2.75 V.

In this cycle test, the ratio of the discharge capacity obtained in the 100th cycle to the discharge capacity obtained in the 1st cycle (“discharge capacity in the 100th cycle”/“discharge capacity in the 1st cycle”) was defined as the “cycle capacity maintenance rate (%)”. The decrease in the average discharge voltage obtained in the 100th cycle relative to the average discharge voltage obtained in the 1st cycle (“1st cycle average discharge voltage”−“100th cycle average discharge voltage”) was defined as an “average discharge voltage decrease (mV)”. The decrease in the coulombic efficiency obtained in the 100th cycle to the coulombic efficiency obtained in the 1st cycle (“1st cycle coulombic efficiency”−“100th cycle coulombic efficiency”) was defined as a “coulombic efficiency decrease (%)”. These results are shown in Tables 1 and 2. The discharge capacity, the average discharge voltage, and the coulombic efficiency of said 100th cycle were estimated by extrapolation using the values obtained in the 20th cycle of the charge/discharge test.

The judgments in Table 2 are indicated with a “◯” mark when all of the following conditions are satisfied: a condition A, that the “cycle capacity maintenance rate” is 95% or more; a condition B, that the absolute value of the “average discharge voltage decrease” is less than 50 mV; and a condition C, that the absolute value of the “coulombic efficiency decrease” is less than 1.5%. When any of the conditions A, B, or C is not satisfied, it is indicated by a “x” mark.

TABLE 1

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.2 | NCM523 | 4.7 | 5.1 | 35 | FEC | 2 | MMDS | 1 |
| example 101 | | | | | | | | | |
| Example 102 | 2.3 | NCM523 | 4.7 | 5.1 | 35 | FEC | 2 | MMDS | 1 |
| Example 101 | 2.5 | NCM523 | 4.7 | 5.1 | 35 | FEC | 2 | MMDS | 1 |
| Example 103 | 2.9 | NCM523 | 4.7 | 5.1 | 35 | FEC | 2 | MMDS | 1 |
| Comparative | 3 | NCM523 | 4.7 | 5.1 | 35 | FEC | 2 | MMDS | 1 |
| example 102 | | | | | | | | | |

TABLE 2

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 160 | 94.3 | −56 | −1.2 | x |
| example 101 | | | | | |
| Example 102 | 164 | 98.3 | −31 | −0.9 | ∘ |
| Example 101 | 164 | 98.1 | −28 | −1.0 | ∘ |
| Example 103 | 165 | 97.9 | −35 | −1.0 | ∘ |
| Comparative | 165 | 93.9 | −33 | −1.1 | x |
| example 102 | | | | | |

From the evaluation results shown in Tables 1 and 2, it was found that the coin-shaped batteries of Examples 101 to 103, in which the density of the positive electrode mixture layer was between 2.3 and 2.9 g/cm³, had excellent cycle characteristics. This is, apparently, because the first positive electrode active materials are closely bonded to each other and that there are adequate voids in the positive electrode mixture layer, so that the impregnation of the non-aqueous electrolyte is good and a uniform film is formed by the first and second additive contained in the non-aqueous electrolyte.

In contrast, the coin-shaped battery of Comparative Example 101, in which the density of the positive electrode mixture layer is 2.2 g/cm³, did not have excellent cycle characteristics. This is because the density of the positive electrode mixture layer is low, the first positive electrode active materials are not tightly bonded to each other, and the first positive electrode active materials are eluted into the non-aqueous electrolyte during charging and discharging, resulting in a decrease in capacity.

The coin-shaped battery of Comparative Example 102, in which the density of the positive electrode mixture layer was 3.0 g/cm³, also failed to exhibit excellent cycle characteristics. This is because the density of the positive electrode mixture layer was too high, which did not generate adequate voids in the positive electrode mixture layer, making it difficult for the non-aqueous electrolyte to impregnate the layer, resulting that the first and second additive contained in the non-aqueous electrolyte did not form a uniform film.

[B]: A Study of the Effect of Conductive Materials in Positive Electrode Mixture

### Examples 201, 202 and Comparative Examples 201, 202

The coin-shaped batteries of Examples 201, 202 and Comparative Examples 201, 202 were fabricated by the same fabrication method as in Example 101, except that the particle diameter distribution D₉₀ of the graphite of the first conductive material was different.

### Examples 203, 204 and Comparative Examples 203, 204

The coin-shaped batteries of Examples 203, 204 and Comparative Examples 203, 204 were fabricated by the same fabrication method as in Example 101, except that the crystallite diameter of the graphite of the first conductive material was different.

### Examples 205, 206 and Comparative Examples 205, 206

The coin-shaped batteries of Examples 205, 206 and Comparative Examples 205, 206 were fabricated by the same fabrication method as in Example 101, except that the average particle diameter of acetylene black of the second conductive material was different.

The performance of the coin-shaped batteries of the obtained Examples 201 to 206 and Comparative Examples 201 to 206 was evaluated for the “cycle capacity maintenance rate (%)”, the “average discharge voltage decrease (mV)”, and the “coulombic efficiency decrease (%)” by the same test method as in the study of [A] above. The results are shown in Tables 3 to 8.

TABLE 3

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 2 | 5.1 | 35 | FEC | 2 | MMDS | 1 |
| example 201 | | | | | | | | | |
| Example 201 | 2.5 | NCM523 | 3 | 5.1 | 35 | FEC | 2 | MMDS | 1 |
| Example 101 | 2.5 | NCM523 | 4.7 | 5.1 | 35 | FEC | 2 | MMDS | 1 |
| Example 202 | 2.5 | NCM523 | 20 | 5.1 | 35 | FEC | 2 | MMDS | 1 |
| Comparative | 2.5 | NCM523 | 25 | 5.1 | 35 | FEC | 2 | MMDS | 1 |
| example 202 | | | | | | | | | |

TABLE 4

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 162 | 89.9 | −66 | −1.2 | x |
| example 201 | | | | | |
| Example 201 | 165 | 95.8 | −40 | −1.1 | ∘ |
| Example 101 | 164 | 98.1 | −28 | −1.0 | ∘ |
| Example 202 | 162 | 96.2 | −38 | −0.8 | ∘ |
| Comparative | 160 | 91.2 | −70 | −1.7 | x |
| example 202 | | | | | |

TABLE 5

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 0.5 | 35 | FEC | 2 | MMDS | 1 |
| example 203 | | | | | | | | | |
| Example 203 | 2.5 | NCM523 | 4.7 | 1 | 35 | FEC | 2 | MMDS | 1 |
| Example 101 | 2.5 | NCM523 | 4.7 | 5.1 | 35 | FEC | 2 | MMDS | 1 |
| Example 204 | 2.5 | NCM523 | 4.7 | 10 | 35 | FEC | 2 | MMDS | 1 |
| Comparative | 2.5 | NCM523 | 4.7 | 15 | 35 | FEC | 2 | MMDS | 1 |
| example 204 | | | | | | | | | |

TABLE 6

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 159 | 93.5 | −51 | −1.3 | x |
| example 203 | | | | | |
| Example 203 | 164 | 96.0 | −33 | −0.9 | ∘ |
| Example 101 | 164 | 98.1 | −28 | −1.0 | ∘ |
| Example 204 | 166 | 97.3 | −36 | −1.1 | ∘ |
| Comparative | 163 | 94.5 | −49 | −1.6 | x |
| example 204 | | | | | |

TABLE 7

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | site | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 5 | FEC | 2 | MMDS | 1 |
| example 205 | | | | | | | | | |
| Example 205 | 2.5 | NCM523 | 4.7 | 5.1 | 10 | FEC | 2 | MMDS | 1 |
| Example 101 | 2.5 | NCM523 | 4.7 | 5.1 | 35 | FEC | 2 | MMDS | 1 |
| Example 206 | 2.5 | NCM523 | 4.7 | 5.1 | 100 | FEC | 2 | MMDS | 1 |
| Comparative | 2.5 | NCM523 | 4.7 | 5.1 | 110 | FEC | 2 | MMDS | 1 |
| example 206 | | | | | | | | | |

TABLE 8

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 161 | 92.1 | −88 | −1.1 | x |
| example 205 | | | | | |
| Example 205 | 165 | 96.4 | −41 | −0.9 | ∘ |
| Example 101 | 164 | 98.1 | −28 | −1.0 | ∘ |
| Example 206 | 162 | 95.2 | −32 | −1.2 | ∘ |
| Comparative | 160 | 94.6 | −55 | −1.2 | x |
| example 206 | | | | | |

From the evaluation results shown in Tables 3 to 8, it was found that the cycle characteristics are improved by controlling the particle diameter distribution D₉₀ of the first conductive material, the crystallite diameter, and the average particle diameter of the second conductive material within a predetermined range as shown in Examples 201 to 206. By controlling the particle diameter distribution D₉₀ of the first conductive material and the average particle diameter of the second conductive material within the predetermined range, it is considered that the first and second conductive materials can easily enter the void between the first positive electrode active materials and a good conductive path is secured. In addition, by controlling the crystallite diameter of the first conductive material within a predetermined range, the conductivity of the first conductive material was suitably maintained while preventing the structural destruction caused by the insertion of anions between the crystalline layers of the first conductive material, resulting in good cycle characteristics.

[C]: A Study of the Effect of Loading of First Additive and Second Additive in Non-Aqueous Electrolyte

### Examples 301, 302 and Comparative Example 304

The coin-shaped batteries of Examples 301, 302 and Comparative Example 304 were fabricated by the same fabrication method as in Example 101, except that the loading of the first additive (FEC) in the non-aqueous electrolyte was different.

### Examples 303, 304 and Comparative Example 305

The coin-shaped batteries of Examples 303, 304 and Comparative Example 305 were fabricated by the same fabrication method as in Example 101, except that the loading of second additive (MMDS) in the non-aqueous electrolyte was different.

### Comparative Example 301

The coin-shaped battery of Comparative Example 301 was fabricated by the same fabrication method as in Example 101, except that the first additive and second additive were not included in the non-aqueous electrolyte.

### Comparative Example 302

The coin-shaped battery of Comparative Example 302 was fabricated by the same fabrication method as in Example 101, except that second additive was not included in the non-aqueous electrolyte.

### Comparative Example 303

The coin-shaped battery of Comparative Example 303 was fabricated by the same fabrication method as in Example 101, except that the first additive was not included in the non-aqueous electrolyte.

The performance of the coin-shaped batteries of the obtained Examples 301 to 304 and Comparative Examples 301 to 305 was evaluated for the “cycle capacity maintenance rate (%)”, the “average discharge voltage decrease (mV)”, and the “coulombic efficiency decrease (%)” by the same test method as in the study of [A] above. The results are shown in Tables 9 to 14.

TABLE 9

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Example 101 | 2.5 | NCM523 | 4.7 | 5.1 | 35 | FEC | 2 | MMDS | 1 |
| Comparative | 2.5 | NCM523 | 4.7 | 5.1 | 35 | — | 0 | — | 0 |
| example 301 | | | | | | | | | |
| Comparative | 2.5 | NCM523 | 4.7 | 5.1 | 35 | FEC | 2 | — | 0 |
| example 302 | | | | | | | | | |
| Comparative | 2.5 | NCM523 | 4.7 | 5.1 | 35 | — | 0 | MMDS | 1 |
| example 303 | | | | | | | | | |

TABLE 10

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Example 101 | 164 | 98.1 | −28 | −1.0 | ∘ |
| Comparative | 165 | 93.0 | −75 | −2.9 | X |
| example 301 | | | | | |
| Comparative | 163 | 93.7 | −69 | −1.2 | X |
| example 302 | | | | | |
| Comparative | 164 | 96.9 | −29 | −1.7 | X |
| example 303 | | | | | |

TABLE 11

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | — | 0 | MMDS | 1 |
| example 301 | | | | | | | | | |
| Example 301 | 2.5 | NCM523 | 4.7 | 5.1 | 35 | FEC | 0.5 | MMDS | 1 |
| Example 101 | 2.5 | NCM523 | 4.7 | 5.1 | 35 | FEC | 2 | MMDS | 1 |
| Example 302 | 2.5 | NCM523 | 4.7 | 5.1 | 35 | FEC | 5 | MMDS | 1 |
| Comparative | 2.5 | NCM523 | 4.7 | 5.1 | 35 | FEC | 7 | MMDS | 1 |
| example 304 | | | | | | | | | |

TABLE 12

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 164 | 96.9 | −29 | −1.7 | x |
| example 301 | | | | | |
| Example 301 | 163 | 98.0 | −33 | −1.1 | ∘ |
| Example 101 | 164 | 98.1 | −28 | −1.0 | ∘ |
| Example 302 | 166 | 97.7 | −37 | −0.8 | ∘ |
| Comparative | 162 | 94.5 | −44 | −0.8 | x |
| example 304 | | | | | |

TABLE 13

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | FEC | 2 | — | 0 |
| example 302 | | | | | | | | | |
| Example 303 | 2.5 | NCM523 | 4.7 | 5.1 | 35 | FEC | 2 | MMDS | 0.1 |
| Example 101 | 2.5 | NCM523 | 4.7 | 5.1 | 35 | FEC | 2 | MMDS | 1 |
| Example 304 | 2.5 | NCM523 | 4.7 | 5.1 | 35 | FEC | 2 | MMDS | 2 |
| Comparative | 2.5 | NCM523 | 4.7 | 5.1 | 35 | FEC | 2 | MMDS | 3 |
| example 305 | | | | | | | | | |

TABLE 14

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 163 | 93.7 | −69 | −1.2 | x |
| example 302 | | | | | |
| Example 303 | 165 | 96.3 | −32 | −0.9 | ∘ |
| Example 101 | 164 | 98.1 | −28 | −1.0 | ∘ |
| Example 304 | 165 | 98.5 | −30 | −1.1 | ∘ |
| Comparative | 160 | 96.2 | −63 | −1.2 | x |
| example 305 | | | | | |

From the evaluation results shown in Tables 9 to 14, it was found that by specifying the loading of the first additive and the second additive within a predetermined range as shown in Examples 301 to 304, it is possible to sufficiently and uniformly form a film having an optimum composition on the surface of the first positive electrode active material, and to improve the cycle characteristics. This is because the first additive is mainly responsible for the formation of high quality SEI on the negative electrode surface and the film formation on the positive electrode active material surface, and the second additive is responsible for the film formation on the positive electrode active material surface.

[D1]: A Study of the Effect of the Type of First Additive in Non-Aqueous Electrolyte

### Examples 401-403 and Comparative Examples 401, 402

The coin-shaped batteries of Examples 401-403 and Comparative Examples 401, 402 having the same coin-shaped battery configuration as Examples 101-103 or Comparative Examples 101, 102 except that the first additive in the non-aqueous electrolyte is VC.

### Examples 404, 405 and Comparative Example 403

The coin-shaped batteries of Examples 404, 405 and Comparative Example 404 were fabricated having the same configuration as in Examples 301, 302 or Comparative Example 304, except that the first additive in the non-aqueous electrolyte was VC.

### Example 406, 407 and Comparative Example 405

The coin-shaped batteries of Examples 406, 407 and Comparative Example 406 were fabricated having the same configuration as in Examples 303, 304 or Comparative Example 305, except that the first additive in the non-aqueous electrolyte was VC.

### Comparative Example 404

The coin-shaped battery of Comparative Example 404 was fabricated having the same configuration as that of Comparative Example 302, except that the first additive in the non-aqueous electrolyte was VC.

The performance of the coin-shaped batteries of the obtained Examples 401 to 407 and Comparative Examples 401 to 405 was evaluated for the “cycle capacity maintenance rate (%)”, the “average discharge voltage decrease (mV)”, and the “coulombic efficiency decrease (%)” by the same test method as in the study of [A] above. The results are shown in Tables 15 to 20.

TABLE 15

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.2 | NCM523 | 4.7 | 5.1 | 35 | VC | 2 | MMDS | 1 |
| example 401 | | | | | | | | | |
| Example 402 | 2.3 | NCM523 | 4.7 | 5.1 | 35 | VC | 2 | MMDS | 1 |
| Example 401 | 2.5 | NCM523 | 4.7 | 5.1 | 35 | VC | 2 | MMDS | 1 |
| Example 403 | 2.9 | NCM523 | 4.7 | 5.1 | 35 | VC | 2 | MMDS | 1 |
| Comparative | 3 | NCM523 | 4.7 | 5.1 | 35 | VC | 2 | MMDS | 1 |
| example 402 | | | | | | | | | |

TABLE 16

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 158 | 93.3 | −90 | −1.1 | x |
| example 401 | | | | | |
| Example 402 | 162 | 99.1 | −30 | −0.8 | ∘ |
| Example 401 | 161 | 99.0 | −25 | −0.9 | ∘ |
| Example 403 | 164 | 98.7 | −31 | −1.0 | ∘ |
| Comparative | 166 | 94.4 | −46 | −1.0 | x |
| example 402 | | | | | |

TABLE 17

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | — | 0 | MMDS | 1 |
| example 301 | | | | | | | | | |
| Example 404 | 2.5 | NCM523 | 4.7 | 5.1 | 35 | VC | 0.5 | MMDS | 1 |
| Example 401 | 2.5 | NCM523 | 4.7 | 5.1 | 35 | VC | 2 | MMDS | 1 |
| Example 405 | 2.5 | NCM523 | 4.7 | 5.1 | 35 | VC | 5 | MMDS | 1 |
| Comparative | 2.5 | NCM523 | 4.7 | 5.1 | 35 | VC | 7 | MMDS | 1 |
| example 403 | | | | | | | | | |

TABLE 18

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 164 | 96.9 | −29 | −1.7 | x |
| example 301 | | | | | |
| Example 404 | 165 | 98.9 | −26 | −1.3 | ∘ |
| Example 401 | 161 | 99.0 | −25 | −0.9 | ∘ |
| Example 405 | 165 | 98.4 | −42 | −1.1 | ∘ |
| Comparative | 163 | 98.0 | −113 | −1.1 | x |
| example 403 | | | | | |

TABLE 19

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | VC | 2 | — | 0 |
| example 404 | | | | | | | | | |
| Example 406 | 2.5 | NCM523 | 4.7 | 5.1 | 35 | VC | 2 | MMDS | 0.1 |
| Example 401 | 2.5 | NCM523 | 4.7 | 5.1 | 35 | VC | 2 | MMDS | 1 |
| Example 407 | 2.5 | NCM523 | 4.7 | 5.1 | 35 | VC | 2 | MMDS | 2 |
| Comparative | 2.5 | NCM523 | 4.7 | 5.1 | 35 | VC | 2 | MMDS | 3 |
| example 405 | | | | | | | | | |

TABLE 20

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 164 | 99.0 | −105 | −1.0 | x |
| example 404 | | | | | |
| Example 406 | 162 | 99.0 | −48 | −0.8 | ∘ |
| Example 401 | 161 | 99.0 | −25 | −0.9 | ∘ |
| Example 407 | 166 | 99.1 | −29 | −0.9 | ∘ |
| Comparative | 167 | 97.2 | −62 | −1.1 | x |
| example 405 | | | | | |

From the evaluation results shown in Tables 15 to 20, it was found that the cycle characteristics can be similarly improved when VC is used instead of FEC as the first additive as shown in Examples 401 to 407. From this finding, it is clear that as long as the type of the first additive is selected from the predetermined substance group, it contributes to the formation of SEI on the negative electrode surface and the formation of a film on the positive electrode active material surface in the same manner, and the cycle characteristic can be improved.

[D2]: A Study of the Effect of the Type of Second Additive in Non-Aqueous Electrolyte

### Examples 501-503 and Comparative Examples 501, 502

The coin-shaped batteries of Examples 501 to 503 and Comparative Examples 501, 502 having the same configuration as Examples 401 to 403 or Comparative Examples 401, 402 except that the second additive in the non-aqueous electrolyte is Li₂PO₂F₂.

### Examples 504, 505 and Comparative Example 504

The coin-shaped batteries of Examples 504, 505 and Comparative Example 504 were fabricated having the same configuration as in Examples 404, 405 or Comparative Example 403, except that the second additive in the non-aqueous electrolyte was Li₂PO₂F₂.

### Example 506, 507 and Comparative Example 505

The coin-shaped batteries of Examples 506, 507 and Comparative Example 505 were fabricated having the same configuration as in Examples 406, 407 or Comparative Example 405, except that the second additive in the non-aqueous electrolyte was Li₂PO₂F₂.

### Comparative Example 503

The coin-shaped battery of Comparative Example 503 was fabricated having the same configuration as in Comparative Example 301, except that the second additive in the non-aqueous electrolyte was Li₂PO₂F₂.

The performance of the obtained coin-shaped batteries of Examples 501 to 507 and Comparative Examples 501 to 505 was evaluated for the “cycle capacity maintenance rate (%)”, the “average discharge voltage decrease (mV)”, and the “coulombic efficiency decrease (%)” by the same test method as in the study of [A] above. The results are shown in Tables 21 to 26.

TABLE 21

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/m³) | substance | D₉₀ (μm) | (nm) | (nm) | Type | (Weight %) | Type | (Weight %) |
| Comparative | 2.2 | NCM523 | 4.7 | 5.1 | 35 | VC | 2 | Li₂PO₂F₂ | 1 |
| example 501 | | | | | | | | | |
| Example 502 | 2.3 | NCM523 | 4.7 | 5.1 | 35 | VC | 2 | Li₂PO₂F₂ | 1 |
| Example 501 | 2.5 | NCM523 | 4.7 | 5.1 | 35 | VC | 2 | Li₂PO₂F₂ | 1 |
| Example 503 | 2.9 | NCM523 | 4.7 | 5.1 | 35 | VC | 2 | Li₂PO₂F₂ | 1 |
| Comparative | 3 | NCM523 | 4.7 | 5.1 | 35 | VC | 2 | Li₂PO₂F₂ | 1 |
| example 502 | | | | | | | | | |

TABLE 22

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgment |
| Comparative | 166 | 94.6 | −45 | −0.8 | x |
| example 501 | | | | | |
| Example 502 | 165 | 95.6 | −32 | −1.0 | ∘ |
| Example 501 | 165 | 98.6 | −22 | −1.2 | ∘ |
| Example 503 | 164 | 96.3 | −41 | −1.1 | ∘ |
| Comparative | 162 | 92.7 | −44 | −0.9 | x |
| example 502 | | | | | |

TABLE 23

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | — | 0 | Li₂PO₂F₂ | 1 |
| example 503 | | | | | | | | | |
| Example 504 | 2.5 | NCM523 | 4.7 | 5.1 | 35 | VC | 0.5 | Li₂PO₂F₂ | 1 |
| Example 501 | 2.5 | NCM523 | 4.7 | 5.1 | 35 | VC | 2 | Li₂PO₂F₂ | 1 |
| Example 505 | 2.5 | NCM523 | 4.7 | 5.1 | 35 | VC | 5 | Li₂PO₂F₂ | 1 |
| Comparative | 2.5 | NCM523 | 4.7 | 5.1 | 35 | VC | 7 | Li₂PO₂F₂ | 1 |
| example 504 | | | | | | | | | |

TABLE 24

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 103 | 92.1 | −106 | −1.8 | x |
| example 503 | | | | | |
| Example 504 | 163 | 96.1 | −28 | −1.2 | ∘ |
| Example 501 | 165 | 98.6 | −22 | −1.2 | ∘ |
| Example 505 | 160 | 96.3 | −46 | −1.2 | ∘ |
| Comparative | 158 | 94.0 | −121 | −0.9 | x |
| example 504 | | | | | |

TABLE 25

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM523 | 4.7 | 5.1 | 35 | VC | 2 | — | 0 |
| example 404 | | | | | | | | | |
| Example 506 | 2.5 | NCM523 | 4.7 | 5.1 | 35 | VC | 2 | Li₂PO₂F₂ | 0.1 |
| Example 501 | 2.5 | NCM523 | 4.7 | 5.1 | 35 | VC | 2 | Li₂PO₂F₂ | 1 |
| Example 507 | 2.5 | NCM523 | 4.7 | 5.1 | 35 | VC | 2 | Li₂PO₂F₂ | 2 |
| Comparative | 2.5 | NCM523 | 4.7 | 5.1 | 35 | VC | 2 | Li₂PO₂F₂ | 3 |
| example 505 | | | | | | | | | |

TABLE 26

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 164 | 99.0 | −105 | −1.0 | x |
| example 404 | | | | | |
| Example 506 | 164 | 98.3 | −42 | −1.1 | ∘ |
| Example 501 | 165 | 98.6 | −22 | −1.2 | ∘ |
| Example 507 | 160 | 99.0 | −33 | −1.1 | ∘ |
| Comparative | 159 | 97.1 | −70 | −1.6 | x |
| example 505 | | | | | |

From the evaluation results shown in Tables 21 to 26, it was found that good cycle characteristics were obtained in the same manner even when Li₂PO₂F₂ was used as the second additive instead of MMDS as shown in Examples 501 to 507. From this fact, it was clarified that as long as the type of the second additive was selected from a predetermined group of substances, it contributed to the formation of a film on the surface of the positive electrode active material in the same manner, and had an effect of improving the cycle characteristics.

In each of the above examples, the same results were obtained when 1,5,2,4-dioxadithiane 2,2,4,4-tetraoxide, phosphorous acid tris (trimethylsilyl), 1-propene 1,3-sultone was used as a second additive in the non-aqueous electrolyte.

[E]: A Study of the Composition of LiₐNiₓCo_{y}M_{1-x-y}O₂, the First Positive Electrode Active Material

The effect of the composition of the first positive electrode active material, LiₐNiₓCo_{y}M_{1-x-y}O₂, on the battery performance was investigated. The coin-shaped batteries were fabricated having the same configuration as in study of [A] by the same fabrication method as described in [A] above, except that the first positive electrode active material was LiNi_{0.8}Co_{0.1} Mn_{0.1}O₂. The performance of the coin-shaped battery was evaluated in terms of the “cycle capacity maintenance rate (%)”, the “average discharge voltage decrease (mV)”, and the “coulombic efficiency decrease (%)” by the same test method as described in [A] above. The results are shown in Tables 27 to 52.

Since LiNi_{0.8}Co_{0.1} Mn_{0.1}O₂, the first positive electrode active material, is generally considered to have more severe cycle degradation, the judgments in Tables 28, 30, 32, 34, 36, 38, 40, 42, 44, 46, 48, 50, and 52 are indicated with a “0” mark when all of the following conditions are satisfied: a condition D that the “cycle capacity maintenance rate” is 90% or more, a condition E that the absolute value of the “average discharge voltage decrease” is less than 100 mV, and a condition F that the absolute value of the “coulombic efficiency decrease” is less than 2.0%. When any of the conditions D, E, or F is not satisfied, it is indicated with a “x” mark.

TABLE 27

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D90 (μm) | (nm) | (nm) | Type | (Weight %) | Type | (Weight %) |
| Comparative | 2.2 | NCM811 | 4.7 | 5.1 | 35 | FEC | 2 | MMDS | 1 |
| example 601 | | | | | | | | | |
| Example 602 | 2.3 | NCM811 | 4.7 | 5.1 | 35 | FEC | 2 | MMDS | 1 |
| Example 601 | 2.3 | NCM811 | 4.7 | 5.1 | 35 | FEC | 2 | MMDS | 1 |
| Example 603 | 2.9 | NCM811 | 4.7 | 5.1 | 35 | FEC | 2 | MMDS | 1 |
| Comparative | 3 | NCM811 | 4.7 | 5.1 | 35 | FEC | 2 | MMDS | 1 |
| example 602 | | | | | | | | | |

TABLE 28

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 203 | 88.7 | −40 | −1.0 | x |
| example 601 | | | | | |
| Example 602 | 200 | 92.8 | −33 | −1.0 | ∘ |
| Example 601 | 201 | 93.1 | −30 | −0.7 | ∘ |
| Example 603 | 198 | 92.2 | −29 | −0.9 | ∘ |
| Comparative | 197 | 87.5 | −32 | −1.1 | x |
| example 602 | | | | | |

TABLE 29

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 2 | 5.1 | 35 | FEC | 2 | MMDS | 1 |
| example 603 | | | | | | | | | |
| Example 604 | 2.5 | NCM811 | 3 | 5.1 | 35 | FEC | 2 | MMDS | 1 |
| Example 601 | 2.5 | NCM811 | 4.7 | 5.1 | 35 | FEC | 2 | MMDS | 1 |
| Example 605 | 2.5 | NCM811 | 20 | 5.1 | 35 | FEC | 2 | MMDS | 1 |
| Comparative | 2.5 | NCM811 | 25 | 5.1 | 35 | FEC | 2 | MMDS | 1 |
| example 604 | | | | | | | | | |

TABLE 30

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 199 | 86.3 | −102 | −1.1 | x |
| example 603 | | | | | |
| Example 604 | 203 | 90.8 | −66 | −0.9 | ∘ |
| Example 601 | 201 | 93.1 | −30 | −0.7 | ∘ |
| Example 605 | 204 | 92.0 | −52 | −0.7 | ∘ |
| Comparative | 208 | 88.3 | −130 | −0.8 | x |
| example 664 | | | | | |

TABLE 31

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 0.5 | 35 | FEC | 2 | MMDS | 1 |
| example 605 | | | | | | | | | |
| Example 606 | 2.5 | NCM811 | 4.7 | 1 | 35 | FEC | 2 | MMDS | 1 |
| Example 601 | 2.5 | NCM811 | 4.7 | 5.1 | 35 | FEC | 2 | MMDS | 1 |
| Example 607 | 2.5 | NCM811 | 4.7 | 10 | 35 | FEC | 2 | MMDS | 1 |
| Comparative | 2.5 | NCM811 | 4.7 | 15 | 35 | FEC | 2 | MMDS | 1 |
| example 606 | | | | | | | | | |

TABLE 32

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 207 | 82.3 | −211 | −0.9 | x |
| example 605 | | | | | |
| Example 606 | 200 | 90.6 | −86 | −0.8 | ∘ |
| Example 601 | 201 | 93.1 | −30 | −0.7 | ∘ |
| Example 607 | 210 | 90.3 | −32 | −0.7 | ∘ |
| Comparative | 198 | 84.6 | −97 | −0.8 | x |
| example 606 | | | | | |

TABLE 33

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 5 | FEC | 2 | MMDS | 1 |
| example 607 | | | | | | | | | |
| Example 608 | 2.5 | NCM811 | 4.7 | 5.1 | 10 | FEC | 2 | MMDS | 1 |
| Example 601 | 2.5 | NCM811 | 4.7 | 5.1 | 35 | FEC | 2 | MMDS | 1 |
| Example 609 | 2.5 | NCM811 | 4.7 | 5.1 | 100 | FEC | 2 | MMDS | 1 |
| Comparative | 2.5 | NCM811 | 4.7 | 5.1 | 110 | FEC | 2 | MMDS | 1 |
| example 608 | | | | | | | | | |

TABLE 34

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 199 | 85.6 | −144 | −0.9 | x |
| example 607 | | | | | |
| Example 608 | 200 | 92.2 | −65 | −0.7 | ∘ |
| Example 601 | 201 | 93.1 | −30 | −0.7 | ∘ |
| Example 609 | 208 | 90.1 | −77 | −0.9 | ∘ |
| Comparative | 200 | 89.6 | −94 | −1.0 | x |
| example 608 | | | | | |

TABLE 35

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Example 601 | 2.5 | NCM811 | 4.7 | 5.1 | 35 | FEC | 2 | MMDS | 1 |
| Comparative | 2.5 | NCM811 | 4.7 | 5.1 | 35 | — | 0 | — | 0 |
| example 610 | | | | | | | | | |
| Comparative | 2.5 | NCM811 | 4.7 | 5.1 | 35 | FEC | 2 | — | 0 |
| example 611 | | | | | | | | | |
| Comparative | 2.5 | NCM811 | 4.7 | 5.1 | 35 | — | 0 | MMDS | 1 |
| example 612 | | | | | | | | | |

TABLE 36

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Example 601 | 201 | 93.1 | −30 | −0.7 | ∘ |
| Comparative | 199 | 85.2 | −232 | −4.8 | x |
| example 610 | | | | | |
| Comparative | 199 | 86.5 | −188 | −1.3 | x |
| example 611 | | | | | |
| Comparative | 198 | 91.3 | −40 | −2.1 | x |
| example 612 | | | | | |

TABLE 37

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | — | 0 | MMDS | 1 |
| example 610 | | | | | | | | | |
| Example 610 | 2.5 | NCM811 | 4.7 | 5.1 | 35 | FEC | 0.5 | MMDS | 1 |
| Example 601 | 2.5 | NCM811 | 4.7 | 5.1 | 35 | FEC | 2 | MMDS | 1 |
| Example 611 | 2.5 | NCM811 | 4.7 | 5.1 | 35 | FEC | 5 | MMDS | 1 |
| Comparative | 2.5 | NCM811 | 4.7 | 5.1 | 35 | FEC | 7 | MMDS | 1 |
| example 613 | | | | | | | | | |

TABLE 36

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 198 | 91.3 | −40 | −2.1 | x |
| example 610 | | | | | |
| Example 610 | 206 | 32.5 | −33 | −1.3 | ∘ |
| Example 601 | 201 | 93.1 | −30 | −0.7 | ∘ |
| Example 611 | 201 | 92.9 | −45 | −0.8 | ∘ |
| Comparative | 198 | 91.6 | −120 | −0.8 | x |
| example 613 | | | | | |

TABLE 39

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | FEC | 2 | — | 0 |
| example 611 | | | | | | | | | |
| Example 612 | 2.5 | NCM811 | 4.7 | 5.1 | 35 | FEC | 2 | MMDS | 0.1 |
| Example 601 | 2.5 | NCM811 | 4.7 | 5.1 | 35 | FEC | 2 | MMDS | 1 |
| Example 613 | 2.5 | NCM811 | 4.7 | 5.1 | 35 | FEC | 2 | MMDS | 2 |
| Comparative | 2.5 | NCM811 | 4.7 | 5.1 | 35 | FEC | 2 | MMDS | 3 |
| example 614 | | | | | | | | | |

TABLE 40

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 199 | 86.8 | −189 | −1.3 | x |
| example 611 | | | | | |
| Example 612 | 210 | 90.8 | −41 | −0.8 | ∘ |
| Example 601 | 201 | 93.1 | −30 | −0.7 | ∘ |
| Example 613 | 205 | 92.5 | −37 | −1.1 | ∘ |
| Comparative | 203 | 92.7 | −120 | −0.9 | x |
| example 614 | | | | | |

TABLE 41

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.2 | NCM811 | 4.7 | 5.1 | 35 | VC | 2 | MMDS | 1 |
| example 615 | | | | | | | | | |
| Example 614 | 2.3 | NCM811 | 4.7 | 5.1 | 35 | VC | 2 | MMDS | 1 |
| Example 615 | 2.5 | NCM811 | 4.7 | 5.1 | 35 | VC | 2 | MMDS | 1 |
| Example 616 | 2.9 | NCM811 | 4.7 | 5.1 | 35 | VC | 2 | MMDS | 1 |
| Comparative | 3 | NCM811 | 4.7 | 5.1 | 35 | VC | 2 | MMDS | 1 |
| example 616 | | | | | | | | | |

TABLE 42

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 203 | 81.9 | −140 | −2.2 | x |
| example 615 | | | | | |
| Example 614 | 198 | 95.0 | −28 | −0.7 | ∘ |
| Example 615 | 197 | 94.6 | −21 | −0.6 | ∘ |
| Example 616 | 205 | 93.2 | −32 | −0.7 | ∘ |
| Comparative | 207 | 87.0 | −42 | −0.9 | x |
| example 616 | | | | | |

TABLE 43

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | — | 0 | MMDS | 1 |
| example 610 | | | | | | | | | |
| Example 617 | 2.5 | NCM811 | 4.7 | 5.1 | 35 | VC | 0.5 | MMDS | 1 |
| Example 615 | 2.5 | NCM811 | 4.7 | 5.1 | 35 | VC | 2 | MMDS | 1 |
| Example 618 | 2.5 | NCM811 | 4.7 | 5.1 | 35 | VC | 5 | MMDS | 1 |
| Comparative | 2.5 | NCM811 | 4.7 | 5.1 | 35 | VC | 7 | MMDS | 1 |
| example 617 | | | | | | | | | |

TABLE 44

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 198 | 91.3 | −40 | −2.1 | x |
| example 610 | | | | | |
| Example 617 | 204 | 92.7 | −29 | −1.3 | ∘ |
| Example 615 | 197 | 94.6 | -21 | −0.6 | ∘ |
| Example 618 | 205 | 94.0 | −49 | −0.2 | ∘ |
| Comparative | 198 | 91.6 | −120 | −0.8 | x |
| example 617 | | | | | |

TABLE 45

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | VC | 2 | — | 0 |
| example 618 | | | | | | | | | |
| Example 619 | 2.5 | NCM811 | 4.7 | 5.1 | 35 | VC | 2 | MMDS | 0.1 |
| Example 615 | 2.5 | NCM811 | 4.7 | 5.1 | 35 | VC | 2 | MMDS | 1 |
| Example 620 | 2.5 | NCM811 | 4.7 | 5.1 | 35 | VC | 2 | MMDS | 2 |
| Comparative | 2.5 | NCM811 | 4.7 | 5.1 | 35 | VC | 2 | MMDS | 3 |
| example 619 | | | | | | | | | |

TABLE 46

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 206 | 92.9 | −121 | −0.9 | x |
| example 618 | | | | | |
| Example 619 | 207 | 95.5 | −48 | −0.7 | ∘ |
| Example 615 | 197 | 94.6 | −21 | −0.6 | ∘ |
| Example 620 | 209 | 93.3 | −20 | −1.1 | ∘ |
| Comparative | 203 | 90.2 | −102 | −1.6 | x |
| example 619 | | | | | |

TABLE 47

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.2 | NCM811 | 4.7 | 5.1 | 35 | VC | 2 | Li₂PO₂F₂ | 1 |
| example 620 | | | | | | | | | |
| Example 621 | 2.3 | NCM811 | 4.7 | 5.1 | 35 | VC | 2 | Li₂PO₂F₂ | 1 |
| Example 622 | 2.5 | NCM811 | 4.7 | 5.1 | 35 | VC | 2 | Li₂PO₂F₂ | 1 |
| Example 623 | 2.9 | NCM811 | 4.7 | 5.1 | 35 | VC | 2 | Li₂PO₂F₂ | 1 |
| Comparative | 3 | NCM811 | 4.7 | 5.1 | 35 | VC | 2 | Li₂PO₂F₂ | 1 |
| example 621 | | | | | | | | | |

TABLE 48

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 205 | 88.9 | −86 | −0.9 | x |
| example 620 | | | | | |
| Example 621 | 207 | 92.1 | −60 | −1.1 | ∘ |
| Example 622 | 203 | 93.0 | −29 | −0.7 | ∘ |
| Example 620 | 206 | 92.6 | −71 | −0.8 | ∘ |
| Comparative | 201 | 86.3 | −78 | −1.2 | x |
| example 621 | | | | | |

TABLE 49

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | — | 0 | Li₂PO₂F₂ | 1 |
| example 622 | | | | | | | | | |
| Example 624 | 2.5 | NCM811 | 4.7 | 5.1 | 35 | VC | 0.5 | Li₂PO₂F₂ | 1 |
| Example 622 | 2.5 | NCM811 | 4.7 | 5.1 | 35 | VC | 2 | Li₂PO₂F₂ | 1 |
| Example 625 | 2.5 | NCM811 | 4.7 | 5.1 | 35 | VC | 5 | Li₂PO₂F₂ | 1 |
| Comparative | 2.5 | NCM811 | 4.7 | 5.1 | 35 | VC | 7 | Li₂PO₂F₂ | 1 |
| example 623 | | | | | | | | | |

TABLE 50

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 206 | 85.2 | −64 | −1.9 | x |
| example 622 | | | | | |
| Example 624 | 200 | 91.1 | −45 | −0.7 | ∘ |
| Example 622 | 190 | 93.0 | −29 | −0.7 | ∘ |
| Example 625 | 206 | 92.2 | −44 | −0.9 | ∘ |
| Comparative | 207 | 90.6 | −133 | −0.8 | x |
| example 623 | | | | | |

TABLE 51

| | | | First | | Second | | | | |
|---|---|---|---|---|---|---|---|---|---|
| | Positive | | conductive | | conductive | First | | Second | |
| | electrode | | material | | material | additive | | additive | |
| | mixture | Positive | Particle | | Average | agent | | agent | |
| | layer | electrode | size | Crystallite | size of | | Addition | | Addition |
| | density | active | distribution | diameter | particle | | amount | | amount |
| | (g/cm³) | substance | D₉₀ (μm) | (nm) | (nm) | Type | (Weight %) | Type | (Weight %) |
| Comparative | 2.5 | NCM811 | 4.7 | 5.1 | 35 | VC | 2 | — | 0 |
| example 618 | | | | | | | | | |
| Example 626 | 2.5 | NCM811 | 4.7 | 5.1 | 35 | VC | 2 | Li₂PO₂F₂ | 0.1 |
| Example 622 | 2.5 | NCM811 | 4.7 | 5.1 | 35 | VC | 2 | Li₂PO₂F₂ | 1 |
| Example 627 | 2.5 | NCM811 | 4.7 | 5.1 | 35 | VC | 2 | Li₂PO₂F₂ | 2 |
| Comparative | 2.5 | NCM811 | 4.7 | 5.1 | 35 | VC | 2 | Li₂PO₂F₂ | 3 |
| example 624 | | | | | | | | | |

TABLE 52

| | Initial | Cycle | | | |
|---|---|---|---|---|---|
| | discharge | capacity | Average discharge | Coulombic | |
| | capacity | maintenance | voltage increase/ | increase/decrease | |
| | (mAh/g) | ratio (%) | decrease (mV) | in efficiency (%) | Judgement |
| Comparative | 203 | 89.3 | −160 | −1.1 | x |
| example 618 | | | | | |
| Example 626 | 192 | 91.1 | −70 | −0.8 | ∘ |
| Example 622 | 203 | 93.0 | −29 | −0.7 | ∘ |
| Example 627 | 203 | 92.1 | −33 | −1.6 | ∘ |
| Comparative | 208 | 88.4 | −65 | −2.1 | x |
| example 626 | | | | | |

From the evaluation results in Tables 27 to 52, it was found that even when LiNi_{0.8}Co_{0.1}Mn_{0.1}O₂ used as the first positive electrode active material as shown in Examples 601 to 627, by combining the fabricating the positive electrode with the predetermined first and second conductive materials and including of the specified first and second additive in the non-aqueous electrolyte in the predetermined amount, the cycle characteristics can be improved.

In addition, NCM having compositions other than LiNi_{0.5}Co_{0.2}Mn_{0.3}O₂ and LiNi_{0.8}Co_{0.1} Mn_{0.1}O₂, which were used as the first positive electrode active material in the each above examples, may be used as the first positive electrode active material. Also, NCA may be used as the first positive electrode active material.

[F1]: A study of using a mixed positive electrode active material obtained by adding a second positive electrode active material (LiCoO₂) to a first positive electrode active material.

### Examples 701-705

The coin-shaped batteries of Examples 701 to 705 were fabricated by the same fabrication method as in Example 101, except that a mixed positive electrode active material obtained by adding a second positive electrode active material (LiCoO₂) to a first positive electrode active material as in Example 101 was used, and the weight ratio of the first positive electrode active material in the mixed positive electrode active material was changed.

The obtained coin-shaped batteries of Examples 701 to 705 were subjected to evaluation tests of discharge load characteristics.

Discharge Load Characteristics Evaluation Test

The initial activation process was performed as in Example 101, and the discharge load test was performed in a thermostatic bath at 25° C. In the first cycle, constant-current and constant-voltage charging at a current of 0.5 C, a voltage of 4.3 V, a cutoff current of 0.05 C, and constant-current discharge at a 0.2 C and a termination voltage of 2.75 V were performed. In the second cycle, constant-current and constant-voltage charging at a current 0.5 C, voltage 4.3 V, a cutoff current of 0.05 C, and constant-current discharging at a 5 C and a termination voltage of 2.75 V were performed. In this evaluation test, the ratio of the discharge capacity of the second cycle to the discharge capacity of the first cycle obtained (“second cycle discharge capacity”/“first cycle discharge capacity”) was defined as “5 C/0.2 C discharge capacity ratio”.

The evaluation results from these evaluation tests are shown in Table 53 below. The judgments in Table 53 are indicated with a “0” mark when condition G that the “5 C/0.2 C discharge capacity ratio” is 85% or more is satisfied. When the condition G is not satisfied, it is indicated with a “0” mark.

TABLE 53

| | | | First | | Second |
|---|---|---|---|---|---|
| | | | conductive | | conductive |
| | | NCM523 | material | | material |
| | Mixed | mixing | Particle size | Crystallite | Average size |
| | active | ratio | distribution | diameter | of particle |
| | substance | (Weight %) | D₉₀ (μm) | (nm) | (nm) |
| Example 701 | NCM523 + | 40 | 4.7 | 5.1 | 35 |
| | LiCoO₂ | | | | |
| Example 702 | NCM523 + | 50 | 4.7 | 5.1 | 35 |
| | LiCoO₂ | | | | |
| Example 703 | NCM523 + | 60 | 4.7 | 5.1 | 35 |
| | LiCoO₂ | | | | |
| Example 704 | NCM523 + | 75 | 4.7 | 5.1 | 35 |
| | LiCoO₂ | | | | |
| Example 705 | NCM523 + | 90 | 4.7 | 5.1 | 35 |
| | LiCoO₂ | | | | |
| Example 101 | NCM523 | 100 | 4.7 | 5.1 | 35 |

| | First | | Second | | | | |
|---|---|---|---|---|---|---|---|
| | additive | | additive | | | | |
| | agent | | agent | | Initial | 5 C/0.2 C | |
| | | Addition | | Addition | discharge | discharge | |
| | | amount | | amount | capacity | capacity | |
| | Type | (Weight %) | Type | (Weight %) | (mAh/g) | ratio (%) | Judgment |
| Example 701 | FEC | 2 | MMDS | 1 | 152 | 84.3 | ◯ |
| Example 702 | FEC | 2 | MMDS | 1 | 155 | 87.1 | ⊚ |
| Example 703 | FEC | 2 | MMDS | 1 | 159 | 88.3 | ⊚ |
| Example 704 | FEC | 2 | MMDS | 1 | 160 | 88.9 | ⊚ |
| Example 705 | FEC | 2 | MMDS | 1 | 163 | 87.2 | ⊚ |
| Example 101 | FEC | 2 | MMDS | 1 | 164 | 83.2 | ◯ |

The evaluation results shown in Table 53 indicate that the coin-shaped batteries of Examples 702 to 705, in which a mixed positive electrode active material is used, in which a second positive electrode active material (LiCoO₂) is added to the first positive electrode active material, and in which the weight ratio of the first positive electrode active material in the mixed positive electrode active material is 50 to 90%, have a high discharge capacity with a 5 C/0.2 C discharge capacity ratio of 85% or more.

[F2]: A study of use of a mixed positive electrode active material obtained by adding a second positive electrode active material (LiMn₂O₄) to a first positive electrode active material.

### Examples 706-709

The coin-shaped batteries of Examples 706 to 709 were fabricated by the same fabrication method as in Example 101, except that a mixed positive electrode active material obtained by adding a second positive electrode active material (LiMn₂O₄) to the first positive electrode active material as in Example 101 was used, and the weight ratio of the first positive electrode active material in the mixed positive electrode active material was changed.

The performance of the obtained coin-shaped batteries of Examples 706 to 709 was evaluated by the same evaluation test as in the study of [F1] above. The results are described in Table 54.

TABLE 54

| | | | First | | Second |
|---|---|---|---|---|---|
| | | | conductive | | conductive |
| | | | material | | material |
| | Mixed | NCM523 | Particle size | Crystallite | Average size |
| | active | mixing ratio | distribution | diameter | of particle |
| | substance | (Weight %) | D₉₀ (μm) | (nm) | (nm) |
| Example 706 | NCM523 + | 50 | 4.7 | 5.1 | 35 |
| | LiMn₂O₄ | | | | |
| Example 707 | NCM523 + | 60 | 4.7 | 5.1 | 35 |
| | LiMn₂O₄ | | | | |
| Example 708 | NCM523 + | 75 | 4.7 | 5.1 | 35 |
| | LiMn₂O₄ | | | | |
| Example 709 | NCM523 + | 90 | 4.7 | 5.1 | 35 |
| | LiMn₂O₄ | | | | |
| Example 101 | NCM523 | 100 | 4.7 | 5.1 | 35 |

| | First | | Second | | | | |
|---|---|---|---|---|---|---|---|
| | additive | | additive | | | | |
| | agent | | agent | | Initial | 5 C/0.2 C | |
| | | Addition | | Addition | discharge | discharge | |
| | | amount | | amount | capacity | capacity | |
| | Type | (Weight %) | Type | (Weight %) | (mAh/g) | ratio (%) | Judgment |
| Example 706 | FEC | 2 | MMDS | 1 | 125 | 84.1 | ◯ |
| Example 707 | FEC | 2 | MMDS | 1 | 140 | 89.2 | ⊚ |
| Example 708 | FEC | 2 | MMDS | 1 | 147 | 90.1 | ⊚ |
| Example 709 | FEC | 2 | MMDS | 1 | 158 | 87.1 | ⊚ |
| Example 101 | FEC | 2 | MMDS | 1 | 164 | 83.2 | ◯ |

The evaluation results shown in Table 54 indicate that the coin-shaped batteries of Examples 707 to 709, in which a mixed positive electrode active material is used, in which a second positive electrode active material (LiMn₂O₄) added to the first positive electrode active material, and in which the weight ratio of the first positive electrode active material in the mixed positive electrode active material is 60 to 90%, have a high discharge capacity with a 5 C/0.2 C discharge capacity ratio of 85% or higher.

[F3]: A study of use of a mixed positive electrode active material obtained by adding a second positive electrode active material (LiMn_{0.7}Fe_{0.3}PO₄) to a first positive electrode active material.

### Examples 710-713

The coin-shaped batteries of Examples 710 to 713 were fabricated by the same fabrication method as in Example 101, except that a mixed positive electrode active material obtained by adding a second positive electrode active material (LiMn_{0.7}Fe_{0.3}PO₄) to the first positive electrode active material as in Example 101 was used, and the weight ratio of the first positive electrode active material in the mixed positive electrode active material was changed.

The obtained coin-shaped batteries of Examples 710 to 713 were subjected to an initial coulombic efficiency evaluation test.

Initial Coulombic Efficiency Evaluation Test

An initial activation process was performed in the same manner as in Example 101, and in the initial activation process, the charge capacity and the discharge capacity of the first cycle were measured, and the ratio of the discharge capacity of the first cycle to the charge capacity of the first cycle (“discharge capacity of the first cycle”/“charge capacity of the first cycle”) obtained was defined as an “initial coulombic efficiency”.

The evaluation results by such evaluation method are shown in Table 55. Note that, for the judgment in Table 55, when both a condition H, that is, the “initial discharge capacity” is 150 mAh/g or more, and a condition I, that is, the “initial coulombic efficiency” is 90% or more, are satisfied, they are indicated with a “0” mark. When either the condition H or I was not satisfied, it was indicated with a “0” mark.

TABLE 55

| | | | First | | Second |
|---|---|---|---|---|---|
| | | | conductive | | conductive |
| | | | material | | material |
| | Mixed | NCM523 | Particle size | Crystallite | Average size |
| | active | mixing ratio | distribution | diameter | of particle |
| | substance | (Weight %) | D₉₀ (μm) | (nm) | (nm) |
| Example 710 | NCM523 + | 50 | 4.7 | 5.1 | 35 |
| | LiMn_{0.7}Fe_{0.3}PO₄ | | | | |
| Example 711 | NCM523 + | 60 | 4.7 | 5.1 | 35 |
| | LiMn_{0.7}Fe_{0.3}PO₄ | | | | |
| Example 712 | NCM523 + | 80 | 4.7 | 5.1 | 35 |
| | LiMn_{0.7}Fe_{0.3}PO₄ | | | | |
| Example 713 | NCM523 + | 90 | 4.7 | 5.1 | 35 |
| | LiMn_{0.7} Fe_{0.3}PO₄ | | | | |
| Example 101 | NCM523 | 100 | 4.7 | 5.1 | 35 |

| | First | | Second | | | | |
|---|---|---|---|---|---|---|---|
| | additive | | additive | | | | |
| | agent | | agent | | Initial | Initial | |
| | | Addition | | Addition | discharge | coulombic | |
| | | amount | | amount | capacity | efficiency | |
| | Type | (Weight %) | Type | (Weight %) | (mAh/g) | (%) | Judgment |
| Example 710 | FEC | 2 | MMDS | 1 | 145 | 94.1 | ◯ |
| Example 711 | FEC | 2 | MMDS | 1 | 151 | 93 | ⊚ |
| Example 712 | FEC | 2 | MMDS | 1 | 160 | 93.2 | ⊚ |
| Example 713 | FEC | 2 | MMDS | 1 | 163 | 92.1 | ⊚ |
| Example 101 | FEC | 2 | MMDS | 1 | 164 | 89.2 | ◯ |

The evaluation results shown in Table 55 indicate that the coin-shaped battery of Examples 710 to 713, in which a mixed positive electrode active material obtained by adding a second positive electrode active material (LiMn_{0.7}Fe_{0.3}PO₄) to the first positive electrode active material was used, and in which the weight ratio of the first positive electrode active material in the mixed positive electrode active material is 60 to 90%, have the first discharge capacity of 150 mAh/g or more and the first coulombic efficiency of 90% or more. Furthermore, it is indicated that the coin-shaped battery of Examples 710 to 713 achieve a balance between the first discharge capacity and the first coulombic efficiency while improving cycle characteristics, and increase energy density in terms of battery design.

[G]: A Study of the Composition of Non-Aqueous Solvent in Non-Aqueous Electrolyte

### Examples 801-810

The coin-shaped batteries of Examples 801 to 810 were fabricated by the same fabrication method as in Example 101, except that, as the non-aqueous solvent, ethylene carbonate (EC), ethyl methyl carbonate (EMC), and dimethyl carbonate (DMC) were used, the composition ratio of EC and EMC was changed, and a mixed non-aqueous solvent was used in which ratio of the composition ratio of DMC to the composition ratio of EMC was changed.

The performance of the obtained coin-shaped batteries of Examples 801 to 810 was evaluated for the “cycle capacity maintenance rate (%)”, the “average discharge voltage decrease (mV)”, and the “coulombic efficiency decrease (%)” by the same test method as in the study of [A] above. The results are shown in Table 56. In Table 56, when the cycle capacity maintenance rate is 95% or more, it is indicated with a “◯” mark, and when it is 98% or more, it is indicated with a “⊚” mark.

TABLE 56

| | | | | | | | Average | Coulombic | |
|---|---|---|---|---|---|---|---|---|---|
| | | | | | Initial | Cycle | discharge | increase/ | |
| | Solvent composition | | | | discharge | capacity | voltage | decrease in | |
| | EC | EMC | DMC | C | capacity | maintenance | increase/ | efficiency | |
| | (Volume %) | (Volume %) | (Volume %) | (DMC/EMC) | (mAh/g) | ratio (%) | decrease (mV) | (%) | Judgment |
| Example 801 | 10 | 50 | 40 | 0.80 | 165 | 95.1 | −33 | −1.1 | ◯ |
| Example 802 | 15 | 50 | 35 | 0.70 | 163 | 98.0 | −27 | −1.2 | ⊚ |
| Example 803 | 20 | 50 | 30 | 0.60 | 164 | 98.1 | −28 | −1.0 | ⊚ |
| Example 804 | 30 | 50 | 20 | 0.40 | 164 | 98.0 | −29 | −1.1 | ⊚ |
| Example 805 | 35 | 50 | 15 | 0.30 | 163 | 96.2 | −35 | −0.9 | ◯ |
| Example 806 | 30 | 30 | 40 | 1.33 | 164 | 96.5 | −41 | −1.2 | ◯ |
| Example 807 | 30 | 35 | 35 | 1.00 | 164 | 98.0 | −33 | −1.0 | ⊚ |
| Example 808 | 20 | 50 | 30 | 0.60 | 164 | 98.1 | −28 | −1.0 | ⊚ |
| Example 809 | 15 | 60 | 25 | 0.42 | 162 | 98.0 | −31 | −0.9 | ⊚ |
| Example 810 | 15 | 65 | 20 | 0.31 | 163 | 97.1 | −44 | −1.1 | ◯ |

From the evaluation results shown in Table 56, it was found that coin-shaped batteries of Examples 801 to 804 and 807 to 809, in which the composition ratios of EC and EMC in the non-aqueous solvent are 15 volume % or more and 30 volume % or less, and 35 volume % or more and 60 volume % or less, respectively, and the ratio of the composition ratio of DMC (B) to the composition ratio of EMC (A) (B/A=C) is specified to be 0.4≤C≤1.0, have a high cycle characteristic with the cycle capacity maintenance rate of 98% or more.

In the cycle test, the ratio of the discharge capacity obtained in the 100th cycle to the discharge capacity obtained in the first cycle is defined as the “cycle capacity maintenance rate (%)”, and the difference between the “⊚” and “◯” judgments is slight, but as the number of cycles increases (e.g. 1000 cycles, 10000 cycles), the difference in cycle performance becomes more remarkable.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

### INDUSTRIAL APPLICABILITY

By including NCM or NCA with a specific electrode density described in the present disclosure as an active material, using it in combination with a positive electrode made by mixing it with a specific conductive material, and using two specific additives in a non-aqueous electrolyte at a predetermined loading, the lithium secondary battery with excellent capacity maintenance rate and the discharge voltage maintenance rate after charge/discharge cycles can be presented. The lithium secondary battery of the present disclosure is suitable for application in the field of industrial batteries and the like, where durability is particularly required in the future, and has an extremely large potential for industrial use.

What is claimed is:

1. A lithium secondary battery comprising a positive electrode, a negative electrode, and non-aqueous electrolyte, wherein
the positive electrode includes a current collector and a positive electrode mixture layer formed on at least one surface of the current collector,
the positive electrode mixture layer contains a first positive electrode active material made of a layered compound represented by a general formula: LiₐNiₓCo_{y}M_{1-x-y} O₂ (where, in the formula, M is at least one selected from a group of Ti, Zr, Nb, W, P, Al, Mg, V, Mn, Ca, Sr, Cr, Fe, B, Ga, In, Si, Mo, Y, Sn, Cu, Ag, and Zn, and a, x, and y are 0.9≤a≤1.2, 0.5≤x≤0.9, 0.1≤y≤0.3, respectively), a first conductive material, and a second conductive material,
the first conductive material has particle diameter distribution D₉₀ between 3 and 20 μm,
the first conductive material has a crystallite diameter between 1 and 10 nm, the crystallite diameter being obtained by a Scherrer's equation based on a peak intensity attributed to (102) face in which 2θ exists within a range of 50 to 52° in an X-ray diffraction pattern derived by means of an X-ray diffraction measurement using Cu-Kα,
the second conductive material has an average particle diameter size between 10 and 100 nm, and
density of the positive electrode mixture layer is between 2.3 and 2.9 g/cm³,
the non-aqueous electrolyte contains lithium salt, a non-aqueous solvent, a first additive, and a second additive,
the first additive is at least one selected from vinylene carbonate and fluoroethylene carbonate, and a loading of the first additive is between 0.5 and 5 wt % of the total weight of the non-aqueous electrolyte, and
the second additive is at least one selected from a group of 1,3,2-dioxathiolane 2,2-dioxide, 1,5,2,4-dioxadithiane 2,2,4,4-tetraoxide, phosphorous acid tris (trimethylsilyl), 1-propene 1,3-sultone, and Li₂PO₂F₂, and a loading of the second additive is between 0.1 and 2 wt % of the total weight of the non-aqueous electrolyte.

2. The lithium secondary battery of claim 1, wherein the first conductive material is graphite or graphene, and the second conductive material is at least one selected from a group of carbon black, activated carbon, and carbon fiber.

3. The lithium secondary battery of claim 1, wherein the positive electrode mixture layer further contains a second positive electrode active material which is LiCoO₂, or a mixture of LiCoO₂ and LiMn₂O₄ or LiMnₓFe₁₋ₓPO₄ (where x is 0.5≤x≤0.9), and
a ratio by weight of the first positive electrode active material with respect to the total weight of the first positive electrode active material and the second positive electrode active material is between 50 and 90 wt %.

4. The lithium secondary battery of claim 1, wherein the positive electrode mixture layer contains a second positive electrode active material which is at least one selected from a group of LiMn₂O₄ and LiMnₓFe₁₋ₓPO₄ (where x is 0.5≤x≤0.9), and
a ratio by weight of the first positive electrode active material with respect to the total weight of the first positive electrode active material and the second positive electrode active material is between 60 and 90 wt %.

5. The lithium secondary battery of claim 1, wherein the surface of the first positive electrode active material is covered with a film of an inorganic compound or a polymer.

6. The lithium secondary battery of claim 1, wherein
the non-aqueous solvent contains ethylene carbonate, dimethyl carbonate, and ethyl methyl carbonate, and
a composition ratio of ethylene carbonate and ethyl methyl carbonate in the non-aqueous solvent is between 15 and 30 vol % and between 35 and 60 vol %, respectively, and
a ratio B/A (C) of composition ratio B of dimethyl carbonate with respect to composition ratio A of ethyl methyl carbonate is 0.4≤C≤1.0.

7. The lithium secondary battery of claim 1, wherein
the negative electrode includes a current collector and a negative electrode mixture layer formed on one or both of surfaces of the current collector, and
the negative electrode mixture layer contains at least one negative electrode active material selected from a group of graphite, amorphous carbon, Si, and SiOₓ (where 0<x≤2).
